(19) United States
(12) Patent Application Publication
(10) Pub. No.: US 2013/0083978 A1
(43) Pub. Date: Apr. 4, 2013

(54) SYSTEMS AND METHODS FOR PROVIDING AUTOMATED IMAGING FEEDBACK

(71) Applicants: Perry Frederick, East Palo Alto, CA (US); Vijaykalyan Yeluri, Campbell, CA (US)

(72) Inventors: Perry Frederick, East Palo Alto, CA (US); Vijaykalyan Yeluri, Campbell, CA (US)

(73) Assignee: General Electric Company, Schenectady, NY (US)

(21) Appl. No.: 13/250,266

(22) Filed: Sep. 30, 2011

(51) Int. Cl. G06K 9/00

(52) U.S. Cl. 382/128

(57) ABSTRACT

Systems and methods for providing automated imaging feedback are described. An example computer-implemented method of automatically providing imaging feedback includes comparing one or more of a series of first images obtained in an ongoing imaging session relating to a patient exam to one or more reference images associated with an exam type corresponding to the patient exam. The example method also includes based on the comparison, automatically generating imaging feedback. The imaging feedback comprising instructions to continue or end the imaging session.

### RELATED APPLICATIONS

Not Applicable

### FEDERALLY SPONSORED RESEARCH OR DEVELOPMENT

Not Applicable

### MICROFICHE/COPYRIGHT REFERENCE

Not Applicable

### BACKGROUND

Using a PACS and/or another workstation, a clinician, such as a radiologist, may perform a variety of activities, such as an image reading, to facilitate a clinical workflow. A reading, such as a radiology or cardiology procedure reading, is a process of a healthcare practitioner, such as a radiologist or a cardiologist, viewing digital images of a patient. The practitioner performs a diagnosis based on content of the diagnostic images and reports on results electronically (e.g., using dictation or otherwise) or on paper.

### BRIEF SUMMARY

Certain examples provide methods, systems, apparatus, and/or articles of manufacture for automated feedback for imaging results.

An example computer-implemented method of automatically providing imaging feedback includes comparing one or more of a series of first images obtained in an ongoing imaging session relating to a patient exam to one or more reference images associated with an exam type corresponding to the patient exam. The example method also includes, based on the comparison, automatically generating imaging feedback. The imaging feedback includes instructions to continue or end the imaging session.

An example automated system for providing imaging feedback includes an image acquirer to retrieve first images obtained from a patient during an imaging session and relating to an exam. The example system also includes an image comparator to retrieve and compare reference images to the first images. The example system also includes an imaging session determinator to, based on the comparison, automatically generate imaging feedback including instructions to continue or end the imaging session.

An example tangible computer-readable storage medium including executable instructions for execution using a processor, wherein the instructions, when executed, provide a system to automatically provide imaging feedback. The example system includes an image acquirer to retrieve first images obtained from a patient during an imaging session and relating to an exam. The example system also includes an image comparator to retrieve and compare reference images to the first images. The example system also includes an imaging session determinator to, based on the comparison, automatically generate imaging feedback including instructions to continue or end the imaging session.

### BRIEF DESCRIPTION OF SEVERAL VIEWS OF THE DRAWINGS

FIG. 1 illustrates an example automated system for imaging feedback.

FIG. 2 is a block diagram of an example processor that can be used to implement the examples disclosed herein.

FIG. 3 depicts an example workflow that can be used to implement the examples disclosed herein.

FIG. 4 shows a flow diagram of an example method of the example automated system for imaging feedback.

FIG. 5 is a block diagram of an example processor system that can be used to implement systems, apparatus, articles of manufacture, and methods shown in FIGS. 1-4 and described herein.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF CERTAIN EXAMPLES

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, at least one of the elements is hereby expressly defined to include a tangible medium such as a memory, a digital video disc (DVD), compact disc (CD), etc. storing the software and/or firmware.

Workflows in many hospitals involve a technologist administering a patient scan for an exam and sending and/or saving the exam and its images to a picture archiving and communication system (PACS). However, prior to sending the images to the PACS, the images of the exam must be reviewed for quality. The person reviewing the images prior to sending and/or saving the exams to the PACS may be the technologist who administered the patient scan and is unqualified to comment on the diagnostic quality of the images associated therewith.

As a result, the images sent and/or saved to the PACS and later reviewed by a radiologist may include quality issues (e.g., poor quality). If the radiologist identifies quality issues with the images taken, the quality issues may be noted in the corresponding report collected and/or stored at the radiation information system (RIS). If the quality of the images is unsatisfactory and the patient is no longer at the healthcare facility, the patient will have to schedule another appointment. At the appointment where the images are retaken, the scanner will be recalibrated for the particular patient and/or exam, scout or calibration images retaken and the scan re-performed. Scout or calibration images are images that are commonly taken to ensure that the region of interest is covered by the scan and/or the scanner is correctly calibrated to scan the patient. Recalibration of the scanner and retaking the scout images may increase patient radiation dosage and/or exposure. A significant amount of time may lapse between the time the exam is administered and the time when the radiologist reviews the images. This lapse in time postpones when the patient learns of the exam results especially if the radiologist determines that the exam must be re-administered due to poor quality images.

In some examples, information relating to the quality of the images taken is used by hospital administrators to quantify the quality of work done by the associated technologist. However, the workflow of grading the technologists based on the images taken does not improve patient care because the images, some of which may be of low quality, are still reviewed and read by the radiologist.

The examples disclosed herein substantially eliminate the limitations of some known approaches by automatically providing substantially immediate or “real time” quality assurance (QA) feedback to a technologist administering the patient exam. Substantially immediate feedback back means that the time to receive the feedback takes into account delays caused by processing capabilities, conveying and/or transferring data, etc. In some examples, the technologist dynamically receives the QA feedback as the scan is performed, when the images reach the PACS and/or scanner, etc. As a result, the technologist may rescan and/or continue to scan the patient and rectify any quality issues that may exist substantially immediately while the patient is still at the healthcare facility, without recalibrating the scanner and without retaking the scout or calibration images which would expose the patient to additional radiation. Using the examples disclosed herein, the images sent and/or saved to the PACS will be of high quality and, thus, the radiologist who later reviews the images no longer has the liability associated with reviewing poor quality images and the possibility of misdiagnosis associated therewith.

To provide the automatic QA feedback to technologists administering the exam, the examples disclosed herein compare one or more of the images obtained from a patient during a patient exam to reference images (e.g., gold standard images, standard images, etc.). The reference images used in the comparison are associated with an exam type corresponding to the patient exam and have optimum image quality in regards to exposure, patient positioning and/or patient labeling. In some examples, the reference images selected to be compared to the patient images are high quality images that were previously acquired for a particular exam from a person having similar demographics, age, etc.

In some examples, the quality of the patient images is compared using a comparison filter. The comparison filter may compare the patient images to the corresponding reference images based on exposure, patient positioning, patient labeling, pixel intensity, high/low resolution, field of view (FOV), noise artifacts, signal to noise ratio (SNR), contrast ratio, etc. The SNR may be determined for one or more of the patient images and the one or more of the corresponding reference images. The determined SNR may be subtracted to determine the noise level of the patient images. In some examples, the SNR determined may be for a region of interest (ROI) for the images that is selected and/or determined (e.g., automatically selected and/or determined) using an algorithm.

Based on the comparison, feedback may be determined. In some examples, the feedback is processed to provide a result indicating to continue or end the imaging session. The feedback may include a quality (e.g., a quality score, quality level) of the patient images, information relating to whether the imaging session is to continue or end, etc. In some examples, the quality score may be negatively impacted based on patient factors such as patient breathing artifacts, changes in the patient's weight, etc. In such examples, the feedback received by the technologist may identify any patient factors that may have affected the quality score. The quality score may be pass/fail, a numeric score (e.g., 1, 2, 3, etc.), a coded score, etc. If the quality score is at or above a predetermined level, the feedback may include instructions to end the imaging session and for the images to be uploaded (e.g., automatically or manually uploaded) to the PACS. For example, if the feedback indicates that there is no deficiency in the images, the imaging session may end. If the quality score is below the predetermined level, the feedback may include instructions to continue the imaging session. For example, if the feedback indicates a deficiency in the images, the imaging session may continue. In some examples, if the quality score is below the predetermined level, the examples described herein will determine the reason why the quality score is low and provide feedback to the technologist regarding the same. If the SNR ratio is different than expected (e.g., off), the feedback may identify patient artifacts, that the patient was breathing during the scan, etc. If the FOV is different than expected (e.g., off), the feedback may include scan parameters used to obtain the reference image.

In some examples, the feedback includes the parameters and/or guidelines used to obtain the reference images. These parameters and/or guidelines may assist and/or provide tips to the technologist in obtaining high(er) quality images. The parameters and/or guidelines may include instructions to stop/terminate the scan, change the scan parameters such as the FOV, kilovolts per milliampere, the dose, etc., to the parameters used to obtain the reference images such that the patient images will be of comparable quality to the reference images. The feedback may be conveyed to the technologist administering the scan within a timeframe that enables the patient to be rescanned, continue to be scanned, etc., if necessary, without requiring the patient to schedule another appointment.

In some examples, the patient images are compared to the reference images at the scanner and then feedback is generated based on the comparison. In other examples, the patient images are conveyed to the PACS where the patient images are compared to the reference images and then feedback is generated based on the comparison. The feedback generated may be conveyed to the technologist administering the exam in any suitable format and/or manner such as, for example, an exam note, an automated phone call, a message sent to a beeper, phone, mobile device, a message (e.g., a pop-up message) at the scanner, etc. In some examples, the feedback includes a quality code (e.g., 1, 2, 3, 4, etc.) and/or patient information. By monitoring and/or reviewing feedback for exams administered by a particular technologist, the examples disclosed herein enable the performance of a technologist to be evaluated and/or for technologists to receive training on how to efficiently perform scans of patients, etc.

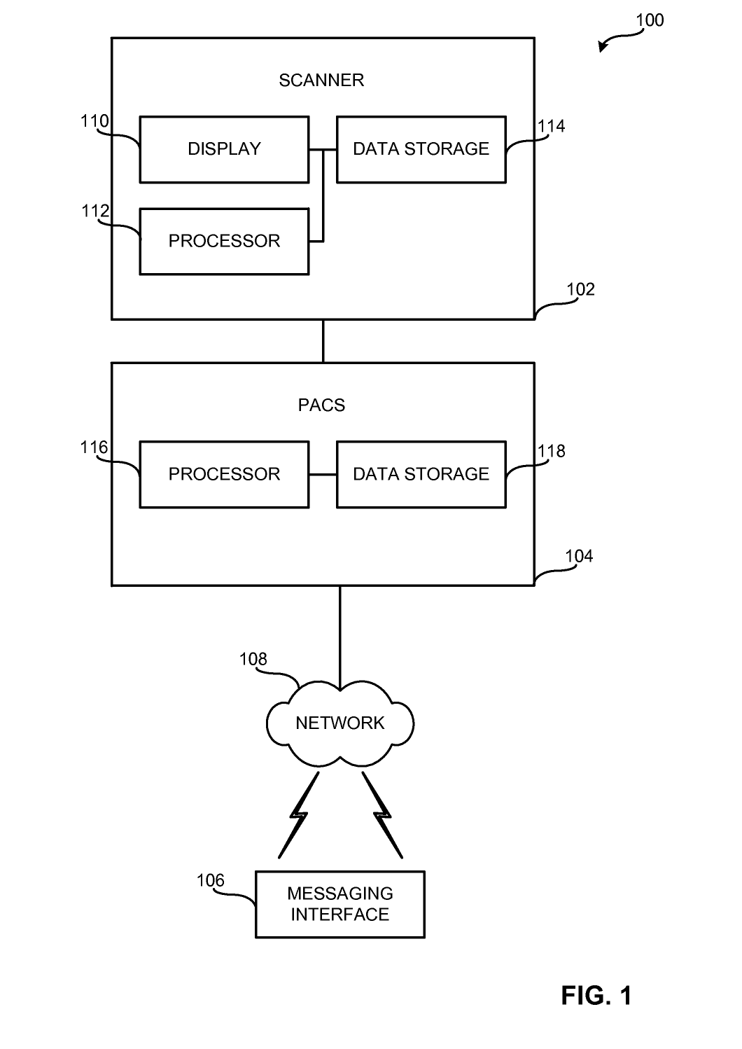

FIG. 1 depicts an example automated system 100 for providing imaging feedback. The system 100 includes a scanner 102, a picture archiving and communication system (PACS) 104, a messaging interface 106 and a network 108. In some examples, the scanner 102, the PACS 104, the messaging interface 106 and/or the network 108 can be implemented in a single system. In some examples, the scanner 102, the PACS 104 and/or the network 108 can communicate with the the messaging interface 106. In some examples, the messaging interface 106 can communicate with the scanner 102, the PACS 104 and/or the network 108. In some examples, the scanner 102 can communicate with the PACS 104, the messaging interface 106 and/or the network 108. The network 108 may be implemented by, for example, a wireless local and/or Wide area Network, a cellular network and/or any other suitable network/router to route data and/or communications between the scanner 102, the PACS 104 and/or the messaging interface 106, etc.

In some examples, the scanner 102 may be used to collect data from a patient, perform an exam/scan (e.g., CT scan, etc.) of the patient and/or generate feedback based on the exam/scan performed. The feedback may include a quality score of the patient images rendered, instructions regarding continuing or ending an imaging session and/or instructions, parameters, guidelines, etc. on how to obtain higher quality images. In some examples, the scanner 102 may interact with the PACS 104 to obtain reference images to which the patient images are compared. Based on the comparison, imaging feedback may be generated associated with the exam/scan performed. In some examples, the scanner 102 may interact with the messaging interface 106 to convey the feedback to the technologist that administered the exam/scan.

The scanner 102 may include a display 110, a processor 112 and a data storage or store 114. The display 110 may display and/or receive input from a technologist administering the exam/scan. The processor 112 may drive components of the scanner 102 and/or cause the scanner 102 to communicate with the PACS 104 and/or the messaging interface 106. In some examples, the processor 112 may prompt the technologist, using the display 110 or otherwise, to enter patient data into the display 110 and/or data relating to the exam to be performed. The processor 112 may request, receive and/or retrieve reference images associated with an exam type corresponding to the patient exam. The reference images may be stored at the data store 114 and/or the PACS 104. The processor 112 may compare one or more of the images obtained during the scan/exam to the corresponding reference images. Based on the comparison, imaging feedback (e.g., a quality level) may be generated associated with the exam/scan performed. The processor 112 may cause the scanner 102 to convey the feedback to the PACS 104 and/or the messaging interface 106. If the patient images obtained are at or above a particular quality level or threshold, the processor 112 may cause the scanner 102 and/or prompt the technologist, via the messaging interface 106, to upload (e.g., automatically or manually upload) the patient images and/or exam results to the PACS 104. Alternatively, if the patient images obtained are below a particular quality level or threshold, the processor 112 may cause the scanner 102 and/or prompt the technologist, via the messaging interface 106, to rescan and/or continue scanning the patient. At least some of the data obtained during a scan/exam, patient data and/or reference images may be stored at the data store 114. The data store 114 may include any variety of internal and/or external memory, disk, remote storage communicating with the processor 112, the display 110, the PACS 104, the messaging interface 106, etc.

In some examples, the PACS 104 may be used to store data and/or generate feedback based on the exam/scan performed. The feedback may include a quality score of the patient images rendered, instructions regarding continuing or ending an imaging session and/or instructions, parameters, etc. on how to obtain higher quality images. The PACS 104 may include a processor 116 and a data storage or store 118. The processor 116 may drive components of the PACS 104 and/or cause the PACS 104 to communicate with the scanner 102 and/or the messaging interface 106. In some examples, the processor 116 may request, receive and/or retrieve patient images stored at the data storage 118 or otherwise (e.g., the scanner 102) and compare one or more of the patient images to the corresponding reference images. Based on the comparison, imaging feedback may be generated associated with the exam/scan performed. The processor 116 may cause the PACS 104 to convey the feedback to the scanner 102 and/or the messaging interface 106. If the patient images obtained are at or above a particular quality level or threshold, the processor 116 may prompt the technologist, via the messaging interface 106, to upload (e.g., manually upload) the patient images and/or exam results to the PACS 104. Additionally or alternatively, if the patient images obtained are at or above a particular quality level or threshold, the processor 116 may upload (e.g., automatically upload) the patient images and/or the exam results to the PACS 104 and/or the data store 118. At least some of the data obtained from the scanner 102, reference images and/or feedback generated may be stored at the data store 118. The data store 118 may include any variety of internal and/or external memory, disk, remote storage communicating with the processor 116, the scanner 102, the messaging interface 106, etc.

The messaging interface 106 may dynamically receive feedback relating to the exam/scan in substantially real time from the scanner 102 and/or the PACS 104. Such feedback may enable the technologist to rescan and/or continue scanning the patient to rectify any quality issues that may exist with the patient images rendered. The feedback may include information relating to the quality of the patient images obtained, instructions relating to whether the imaging session should continue or end, instructions, parameters, guidelines, etc. that assist the technologist in obtaining higher quality images, etc. The messaging interface 106 can be implemented using a workstation (e.g., a laptop, a desktop, a tablet computer, etc.) or a mobile device, for example. Some mobile devices include smart phones (e.g., B1ackBerry™, iPhone™, etc.), Mobile Internet Devices (MID), personal digital assistants, cellular phones, handheld computers, tablet computers (iPad™), pagers. etc., for example.

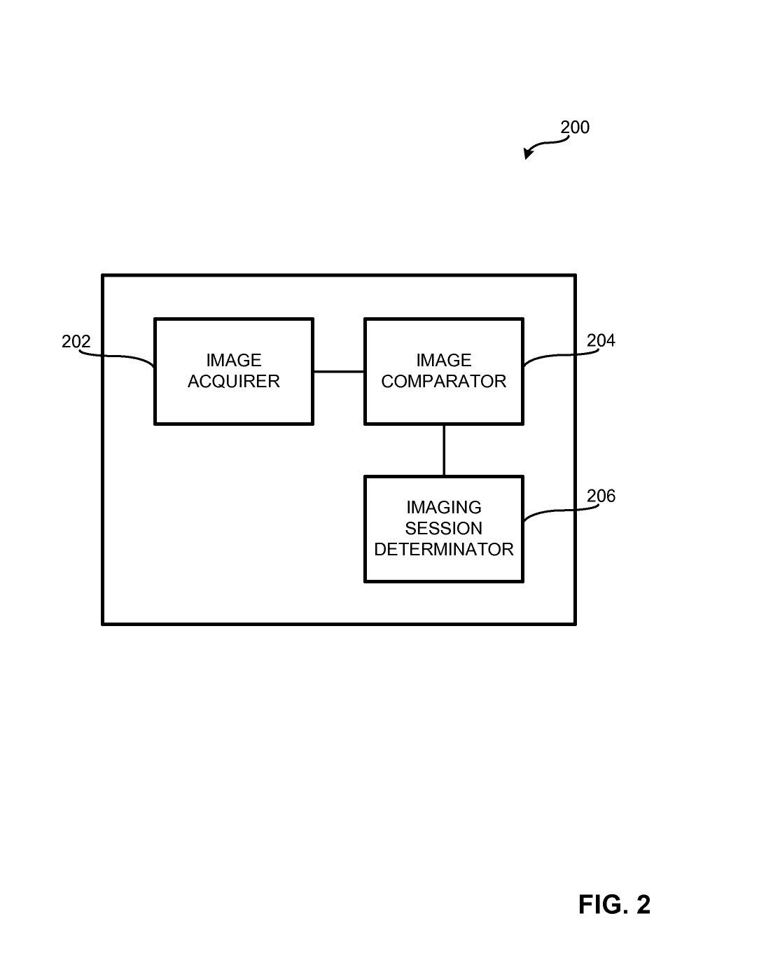

FIG. 2 depicts an example processor 200 that may be used to implement the processors 112 and/or 116 of FIG. 1 or, more generally, the examples disclosed herein. The processor 200 includes an image acquirer 202, an image comparator 204 and an image session determinator 206. The image acquirer 202 may be used to retrieve and/or obtain a series of images from an ongoing imaging session relating to a patient exam and/or reference images associated with an exam type corresponding to the patient exam. The image comparator 204 may compare one or more of the series of images from the patient exam to the corresponding reference images. In some examples, the image comparator 204 may compare the quality, exposure, patient positioning, patient labeling, etc., of one or more of the series of images from the patient exam to the corresponding reference images. Based on the comparison, the imaging session determinator 206 may generate feedback. The feedback may include information relating to the quality of the patient images rendered, instructions relating to whether the imaging session should continue or end, instructions, parameters, guidelines, etc. that assist the technologist in obtaining higher quality images, etc. In some examples, the processor 200 may convey the feedback to a messaging interface associated with the healthcare practitioner (e.g., the technologist) that administered the exam. If the imaging session determinator 206 determines that imaging session is to end, the processor 200 may convey and/or store (e.g., automatically) the exam/images at a data store (e.g., PACS).

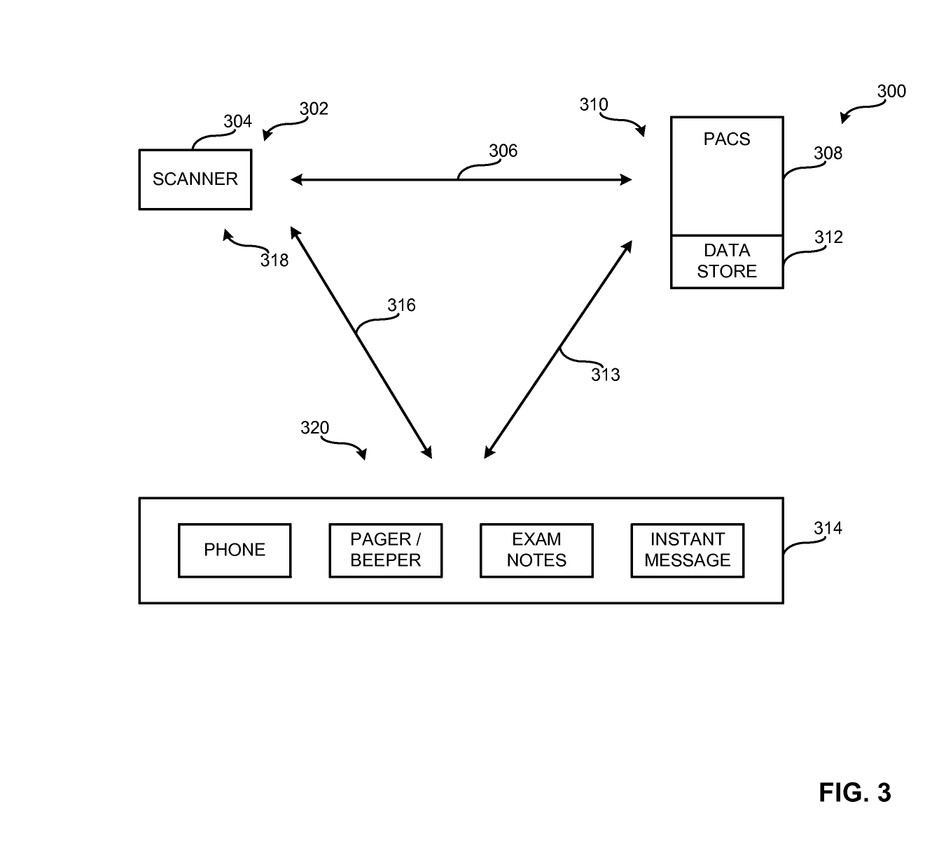

FIG. 3 depicts an example workflow 300. The workflow may begin at 302 by a technologist performing a scan of a patient using a scanner 304. At arrow 306, the exam results, including its associated images, may be conveyed to a PACS 308. In such examples, at 310, the PACS 308 compares the images from the exam to reference images retrieved from a data store 312 and generates feedback based thereon. At arrow 313, the feedback generated may be conveyed to a messaging interface 314 which in turn relays the feedback to the technologist in substantially real time and/or instantaneously at arrow 316. The messaging interface 314 may be in the form of a phone message, the scanner message, pager and/or beeper message, exam note(s), instant message(s), etc. Providing the technologist with feedback from the exam in substantially real time may enable the technologist to rescan and/or continue scanning the patient to rectify any quality issues that may exist with the patient images rendered while the patient is still at the healthcare facility and/or appointment.

Alternatively, at arrow 306, the PACS 308 may convey reference images corresponding to the exam performed from the data store 312 to the scanner 304. In such examples, at 318, the scanner 304 compares the images from the exam to the reference images and generates feedback based thereon. At 320, the feedback generated may be conveyed to the messaging interface 314 which in turn relays the feedback to the technologist in substantially real time and/or instantaneously at arrow 316.

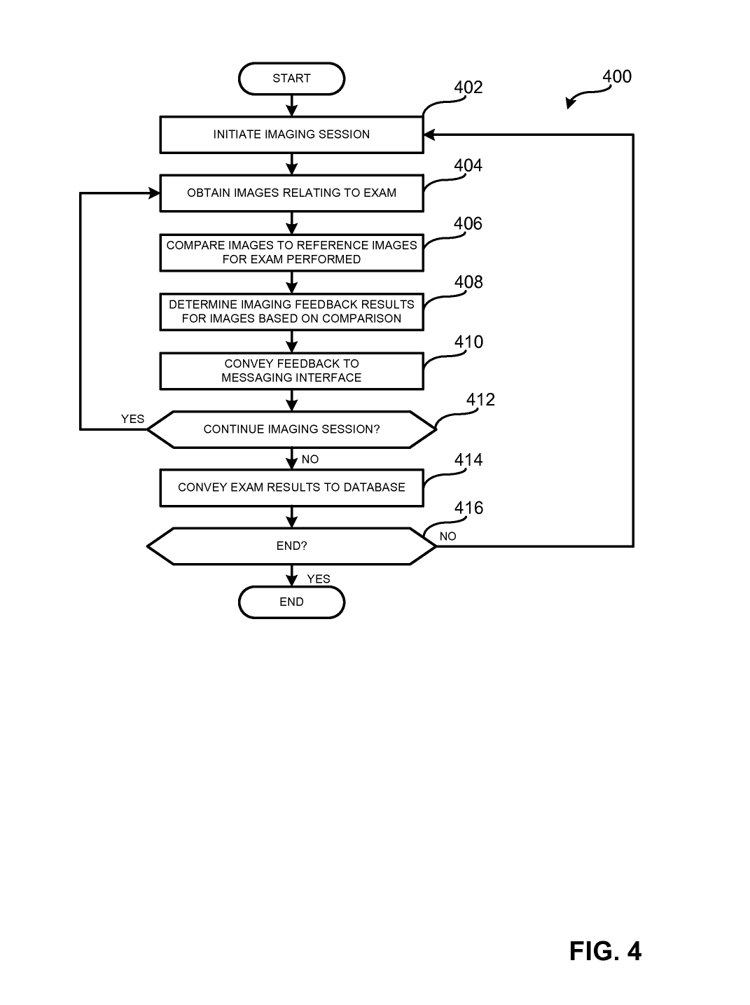

FIG. 4 depicts an example flow diagram representative of processes that may be implemented using, for example, computer readable instructions that may be used to automatically provide imaging feedback and/or results. The example processes of FIG. 4 may be performed using a processor, a controller and/or any other suitable processing device. For example, the example processes of FIG. 4 may be implemented using coded instructions (e.g., computer readable instructions) stored on a tangible computer readable medium such as a flash memory, a read-only memory (ROM), and/or a random-access memory (RAM). As used herein, the term tangible computer readable medium is expressly defined to include any type of computer readable storage and to exclude propagating signals. Additionally or alternatively, the example processes of FIG. 4 may be implemented using coded instructions (e.g., computer readable instructions) stored on a non-transitory computer readable medium such as a flash memory, a read-only memory (ROM), a random-access memory (RAM), a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, some or all of the example processes of FIG. 4 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIG. 4 may be implemented manually or as any combination(s) of any of the foregoing techniques, for example, any combination of firmware, software, discrete logic and/or hardware. Further, although the example processes of FIG. 4 are described with reference to the flow diagram of FIG. 4, other methods of implementing the processes of FIG. 4 may be employed. For example, the order of execution of the blocks may be changed, and/or some of the blocks described may be changed, eliminated, sub-divided, or combined. Additionally, any or all of the example processes of FIG. 4 may be performed sequentially and/or in parallel by, for example, separate processing threads, processors, devices, discrete logic, circuits, etc.

FIG. 4 shows a flow diagram of an example method 400 to automatically provide imaging feedback. The example process illustrates how the examples disclosed herein provide technologists administering scans/exams with quality assurance feedback substantially immediately and enable radiologists reviewing the exams to only be provided with exams meetings particular quality specifications. The example process also illustrates how the disclosed examples substantially eliminate the possibility that a patient has to return to the healthcare facility to have a scan re-executed based on the quality of the images rendered. As such, the quality of patient care is increased, the radiation dosage received by patients may be minimized, etc.

At block 402, the method 400 initiates an imaging session. The imaging session may be initiated by a technologist entering data (e.g., patient data, exam data, etc.) into a scanner, for example. The method 400 may then obtain the images relating to the exam. (block 404). The images may be obtained by a scanner and/or by the PACS during and/or after the scan/exam. At block 406, the patient images are compared to reference images for the exam performed. These images may be compared at the scanner and/or at the PACS, etc. The reference images used in the comparison are associated with an exam type corresponding to the patient exam and have optimum image quality in regards to exposure, patient positioning and/or patient labeling.

At block 408, the method 400 determines imaging feedback based on the comparison. The imaging feedback may include information relating to the quality (e.g., a quality score and/or code determined) of the patient images rendered, instructions relating to whether the imaging session should continue or end, instructions, parameters, guidelines, etc. that assist the technologist in obtaining higher quality images, patient information, etc. At block 410, the method 400 may convey the feedback to a messaging interface. The messaging interface may be associated with the technologist administering the exam and may be associated with at least one of a phone, the scanner, a mobile device, a pager, an exam note or an instant message.

At block 412, the method 400 determines whether or not to continue the imaging session. The imaging session may continue if a determined quality score of the images obtained is below a predetermined level. The imaging session may end if the determined quality score of the images obtained is at or above the predetermined level. If the method 400 determines to continue the imaging session, control moves to block 404. However, if the method 400 determines to end the imaging session, control moves to block 414 where the method 400 conveys the exam results to a data store. The exam results and/or associated images may be manually and/or automatically uploaded to the PACS, for example. At block 416, the method 400 determines or not to end.

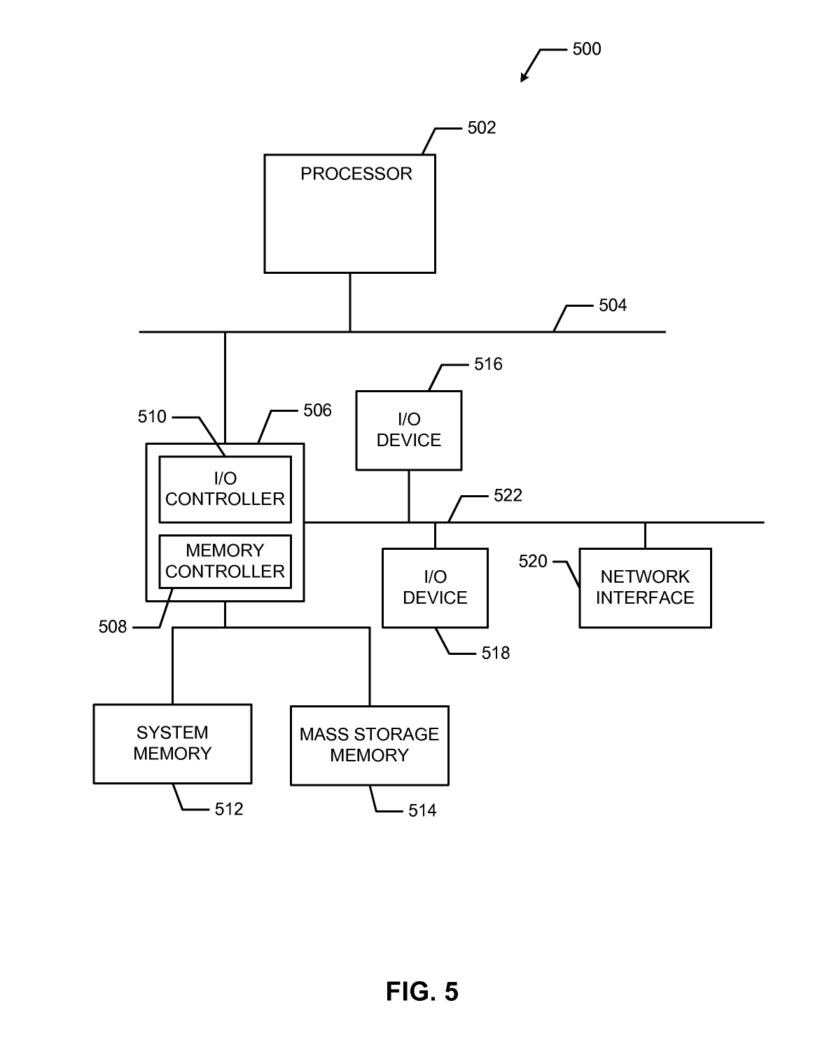

FIG. 5 is a block diagram of an example processor system 500 that may be used to implement the systems and methods described herein. As shown in FIG. 5, the processor system 500 includes a processor 502 that is coupled to an interconnection bus 504. The processor 502 may be any suitable processor, processing unit or microprocessor. Although not shown in FIG. 5, the processor system 500 may be a multi-processor system and, thus, may include one or more additional processors that are identical or similar to the processor 502 and that are communicatively coupled to the interconnection bus 504.

The processor 502 of FIG. 5 is coupled to a chipset 506, which includes a memory controller 508 and an input/output (I/O) controller 510. As is well known, a chipset typically provides I/O and memory management functions as well as a plurality of general purpose and/or special purpose registers, timers, etc. that are accessible or used by one or more processors coupled to the chipset 506. The memory controller 508 performs functions that enable the processor 502 (or processors if there are multiple processors) to access a system memory 512 and a mass storage memory 514.

The system memory 512 may include any desired type of volatile and/or non-volatile memory such as, for example, static random access memory (SRAM), dynamic random access memory (DRAM), flash memory, read-only memory (ROM), etc. The mass storage memory 514 may include any desired type of mass storage device including hard disk drives, optical drives, tape storage devices, etc.

The I/O controller 510 performs functions that enable the processor 502 to communicate with peripheral input/output (I/O) devices 516 and 518 and a network interface 520 via an I/O bus 522. The I/O devices 516 and 518 may be any desired type of I/O device such as, for example, a keyboard, a video display or monitor, a mouse, etc. The network interface 520 may be, for example, an Ethernet device, an asynchronous transfer mode (ATM) device, an 802.11 device, a DSL modem, a cable modem, a cellular modem, etc. that enables the processor system 500 to communicate with another processor system.

While the memory controller 508 and the I/O controller 610 are depicted in FIG. 5 as separate blocks within the chipset 506, the functions performed by these blocks may be integrated within a single semiconductor circuit or may be implemented using two or more separate integrated circuits.

The examples disclosed herein relate to systems and methods for automatically providing imaging feedback to technologist, which eliminates at least some of the issues encountered with known approaches. For example, the examples disclosed herein enable the technologist obtaining images of a patent to receive feedback regarding the imaging quality substantially immediately without the requirement of having a doctor (e.g., radiologist) review the images. Thus, if the images are not of a particular quality (e.g., a poor quality), the technologist can continue the imaging session with the patient to obtain images of higher quality. With known approaches, if the doctor identifies that the images are of poor quality, the patient will likely have already left the healthcare facility and, thus, will have to schedule another appointment. Additionally or alternatively, using the examples disclosed, the quality of the images reviewed by the doctor (e.g., radiologist) is dramatically increased because all of the images meet are at least of a particular quality standard. By ensuring the images reviewed by the doctor are all of a particular quality, the quality of patient care is increased as well as the efficiency of the doctor (e.g., because no time is wasted reviewing poor quality images).

Certain examples contemplate methods, systems and computer program products on any machine-readable media to implement functionality described above. Certain examples can be implemented using an existing computer processor, or by a special purpose computer processor incorporated for this or another purpose or by a hardwired and/or firmware system, for example.

Some or all of the system, apparatus, and/or article of manufacture components described above, or parts thereof, can be implemented using instructions, code, and/or other software and/or firmware, etc. stored on a machine accessible or readable medium and executable by, for example, a processor (e.g., the example processor 116 of FIG. 1). When any of the appended claims are read to cover a purely software and/or firmware implementation, at least one of the components is hereby expressly defined to include a tangible medium such as a memory, DVD, CD, etc. storing the software and/or firmware.

FIGS. 1-5 include data and/or process flow diagrams representative of machine readable and executable instructions or processes that can be executed to implement the example systems, apparatus, and article of manufacture described herein. The example processes of FIGS. 1-5 can be performed using a processor, a controller and/or any other suitable processing device. For example, the example processes of FIGS. 1-5 can be implemented in coded instructions stored on a tangible medium such as a flash memory, a read-only memory (ROM) and/or random-access memory (RAM) associated with a processor (e.g., the processors 112, 116 of FIG. 1, the processor 200 of FIG. 2, etc.). Alternatively, some or all of the example processes of FIGS. 1-5 can be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIGS. 1-5 can be implemented manually or as any combination(s) of any of the foregoing techniques, for example, any combination of firmware, software, discrete logic and/or hardware. Further, although the example processes of FIGS. 1-3 are described with reference to the flow diagrams of FIG. 4, other methods of implementing the processes of FIGS. 1-35 can be employed. For example, the order of execution of the blocks may be changed, and/or some of the blocks described may be changed, eliminated, sub-divided, or combined. Additionally, any or all of the example processes of FIGS. 1-5 can be performed sequentially and/or in parallel by, for example, separate processing threads, processors, devices, discrete logic, circuits, etc.

One or more of the components of the systems and/or blocks of the methods described above may be implemented alone or in combination in hardware, firmware, and/or as a set of instructions in software, for example. Certain examples may be provided as a set of instructions residing on a computer-readable medium, such as a memory, hard disk, DVD, or CD, for execution on a general purpose computer or other processing device. Certain examples may omit one or more of the method blocks and/or perform the blocks in a different order than the order listed. For example, some blocks may not be performed in certain embodiments of the present invention. As a further example, certain blocks may be performed in a different temporal order, including simultaneously, than listed above.

Certain examples include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Examples may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Examples of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of embodiments of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated computer-readable media provide nonvolatile storage of computer-executable instructions, data structures, program modules and other data for the computer.

While the invention has been described with reference to certain embodiments/examples, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A computer-implemented method of automatically providing imaging feedback, comprising:
comparing one or more of a series of first images obtained in an ongoing imaging session relating to a patient exam to one or more reference images associated with an exam type corresponding to the patient exam; and
based on the comparison, automatically generating imaging feedback, the imaging feedback comprising instructions to continue or end the imaging session.

2. The method of claim 1, wherein generating imaging feedback comprises determining a quality score for the first images.

3. The method of claim 2, wherein generating imaging feedback comprising instructions to end the imaging session is based on the quality score being at or above a predetermined level.

4. The method of claim 1, wherein the first images are uploaded to a picture archiving and communication system based on generating imaging feedback comprising instructions to end the imaging session.

5. The method of claim 4, wherein the first images are automatically uploaded to the picture archiving and communication system based on generating imaging feedback comprising instructions to end the imaging session.

6. The method of claim 1, further comprising obtaining a series of second images relating to the exam based on generating feedback comprising instructions to continue the imaging session.

7. The method of claim 1, wherein generating imaging feedback comprising instructions to continue the imaging session comprises providing a healthcare practitioner with parameters used to obtain the reference images.

8. The method of claim 1, further comprising notifying a healthcare practitioner of the imaging feedback via a messaging interface.

9. The method of claim 8, wherein the messaging interface is associated with at least one of a phone, a mobile device, a scanner, a pager, an exam note, or an instant message.

10. The method of claim 1, further comprising evaluating a performance of a healthcare practitioner based on the imaging feedback.

11. The method of claim 1, wherein comparing one or more of the first images to the reference images comprises comparing at least one of exposure, patient positioning, or patient labeling of the first and reference images.

12. The method of claim 1, wherein the imaging feedback comprise a quality code and patient information.

13. An automated system for providing imaging feedback, comprising:
an image acquirer to retrieve first images obtained from a patient during an imaging session and relating to an exam;
an image comparator to retrieve and compare reference images to the first images; and
an imaging session determinator to, based on the comparison, automatically generate imaging feedback comprising instructions to continue or end the imaging session.

14. The automated system of claim 13, wherein the imaging feedback comprises a quality score for the first images.

15. The automated system of claim 13, further comprising a processor to convey the imaging feedback to a messaging interface associated with a healthcare practitioner.

16. The automated system of claim 13, further comprising a processor to convey the first images to a picture archiving and communication system based on the image determinator generating imaging feedback comprising instructions to end the imaging session.

17. The automated system of claim 13, wherein the imaging feedback comprises a quality code and patient information.

18. The automated system of claim 13, wherein generating imaging feedback comprises determining a quality score for the first images.

19. The automated system of claim 18, wherein generating imaging feedback comprising instructions to end the imaging session is based on the quality score being at or above a predetermined level.

20. A tangible computer-readable storage medium including executable instructions for execution using a processor, wherein the instructions, when executed, provide a system to automatically provide imaging feedback, the system comprising:
an image acquirer to retrieve first images obtained from a patient during an imaging session and relating to an exam;
an image comparator to retrieve and compare reference images to the first images; and
an imaging session determinator to, based on the comparison, automatically generate imaging feedback comprising instructions to continue or end the imaging session.
